(19) United States
(12) Patent Application Publication
(10) Pub. No.: US 2007/0010362 A1
(43) Pub. Date: Jan. 11, 2007

(54) Wraparound drive

(75) Inventors: Michael Bogner, Eckental (DE); Rainer Pflug, Heilsbronn (DE)

Correspondence Address: LUCAS & MERCANTI, LLP, 475 PARK AVENUE SOUTH, 15TH FLOOR, NEW YORK, NY, 10016, US

(73) Assignee: Schaeffler KG, Herzogenaurach (DE)

(21) Appl. No.: 11/482,477

(22) Filed: Jul. 7, 2006

Related U.S. Application Data
(60) Provisional application No. 60/697,922, filed on Jul. 8, 2005.

(51) Int. Cl. F16H 55/30

(52) U.S. Cl. 474/141

(57) ABSTRACT

The invention relates to a wraparound drive (1), with a wraparound means (6) at least one driving traction element pulley (2) and at least one driven traction element pulley (3) and also a tensioning device (4) arranged on the slack strand (8) of the wraparound drive (1), the at least one driving traction element pulley (2) and/or the at least one driven traction element pulley (3) being noncircular and/or eccentrically mounted.

In order for the performance of a wraparound drive (1) of the generically determinative type, which may already be operated to its limits, to be further increased, or at least to be able to be maintained, with reduced technical effort and outlay on material, the tensioning device (4) comprises a noncircular tensioning roller (4a) which in turn can be positioned with respect to the wraparound means (6) via an eccentric (7) and can be fastened to produce a fixed point of rotation (9).

### FIELD OF THE INVENTION

The invention relates to a wraparound drive, with a wraparound means, at least one driving traction element pulley and at least one driven traction element pulley and also with a tensioning device arranged on the slack strand of the wraparound drive, the at least one driving traction element pulley and/or the at least one driven traction element pulley being noncircular and/or eccentrically mounted.

### BACKGROUND OF THE INVENTION

Use is made particularly in motor vehicles of belt or chain drives in which a crankshaft drives the camshafts of an internal combustion engine, these camshafts allowing the inlet valves or outlet valves of said internal combustion engine to be actuated. Moreover, this or a separate belt or chain drive can also be used to drive auxiliary units, such as, for example, a water pump, an air-conditioning system, an electric generator, etc.

As a result of torque fluctuations or angular velocity and rotational speed variations, belt or chain drives are exposed during operation to mechanical vibration excitations which for their part load the belt or chain drive. Such vibrations disadvantageously lead within resonance ranges to audible noises. Associated therewith are increased frictional forces which negatively affect the service life of the wraparound drive and its efficiency. Furthermore, its susceptibility to failure increases as a result, and driving comfort, for example in a motor vehicle, decreases.

In order to effectively counter these problems, it is already known for at least one driving and/or a driven wheel, also referred to as a pulley, to be given a noncircular design and/or be eccentrically mounted. This measure brings about a so-called detuning of the wraparound drive by means of an additional irregularity of shape, thereby shifting critical resonance ranges to a nondisruptive range. Reference may be made in this respect to DE 195 20 508 A1 and US 2003/0104886 A1, for example.

DE 195 20 508 A1 also discloses combining the aforementioned noncircular and/or eccentrically mounted wheels or pulleys with a belt, in particular with a toothed belt, which in turn is designed to have a variable longitudinal elasticity.

This publication further proposes that a spring-loaded tensioning wheel, which is known per se and arranged in the slack strand of the wraparound drive, be given a noncircular design and/or be eccentrically mounted, as a result of which it is likewise intended to be able to produce a resonance shift.

The as yet unpublished German patent application P 10 2004 025 936.4 also proposes a wraparound drive for an internal combustion engine with a wraparound means in the form of a belt or chain which is guided via driving wheels and driven wheels of the crankshaft and at least one camshaft of the internal combustion engine and/or auxiliary units which are to be driven. Provision is essentially made here to design at least one of the driving wheels or driven wheels or a deflection wheel to be noncircular or eccentric and/or to provide at least two tensioning rollers, with one of these tensioning rollers being provided with a damping device or both of them being coupled together by means of a damping device.

It is undoubtedly the case that the above measures make it possible to achieve a defined resonance shift which produces an advantageous effect on the operation and the efficiency of the wraparound drive and on the driving comfort of a motor vehicle having such a wraparound drive.

Nevertheless the above measures, in particular those relating to the tensioning device, are still associated with considerable complexity. This is where the invention described below comes in.

### OBJECT OF THE INVENTION

The object on which the invention is based is for the performance of a wraparound drive of the generically determinative type, which may already be operated to its limits, to be further increased, or at least maintained, with reduced technical effort and outlay on material.

### SUMMARY OF THE INVENTION

It has been found, surprisingly, from tests that, for the purpose of tensioning the wraparound means, there is no need for an elaborate and therefore cost-intensive tensioning device, with for example a spring-loaded or automatically retensioning tensioning roller, if at least one driving or driven traction element pulley is of noncircular design or eccentrically mounted in a manner known per se.

The invention therefore starts from a wraparound drive with a wraparound means, with at least one driving traction element pulley and at least one driven traction element pulley and also with a tensioning device arranged in the slack strand of the wraparound drive, the at least one driving traction element pulley and/or the at least one driven traction element pulley being noncircular and/or eccentrically mounted. It is also possible according to the invention to provide the tensioning device with a noncircular tensioning roller which for its part can be positioned with respect to the wraparound means via an eccentric and can be fastened to produce a fixed point of rotation.

This measure, namely the combination of at least one noncircular and/or eccentrically mounted traction element pulley with a circular tensioning roller, makes it possible in a particularly advantageous manner to dispense with conventional complicated and costly automatic adjusting or readjusting means for the tensioning device, while at the same time retaining or even improving the known advantages with regard to the elimination of vibration, accompanied by reduced noise and increased efficiency.

The subclaims associated with this independent claim describe preferred developments or refinements of the invention.

Accordingly, it is additionally possible for one or more noncircular and/or eccentrically mounted damping rollers to be arranged in the slack strand and/or in the tight strand of the wraparound drive, these damping rollers for their part, as the description thereof already demonstrates, advantageously contributing to stabilization of the drive.

As the invention further provides, it has proved expedient for a damping roller arranged in the slack strand to be arranged, as seen in the running direction of the wraparound means, behind the tensioning device in the form of the noncircular tensioning roller with a fixed point of rotation.

Finally, it is possible through the use of an elastomer belt, instead of a conventional toothed belt, a chain or the like, for the performance of the wraparound drive or the elimination of vibration to be increased still further.

### BRIEF DESCRIPTION OF THE DRAWINGS

The invention will be explained in more detail below by way of some embodiments with reference to the appended drawing, in which:

FIG. 1 schematically shows a wraparound drive designed according to the invention for an internal combustion engine, and

FIG. 2 shows, in detail, a tensioning device of the wraparound drive according to FIG. 1.

### DETAILED DESCRIPTION OF THE DRAWINGS

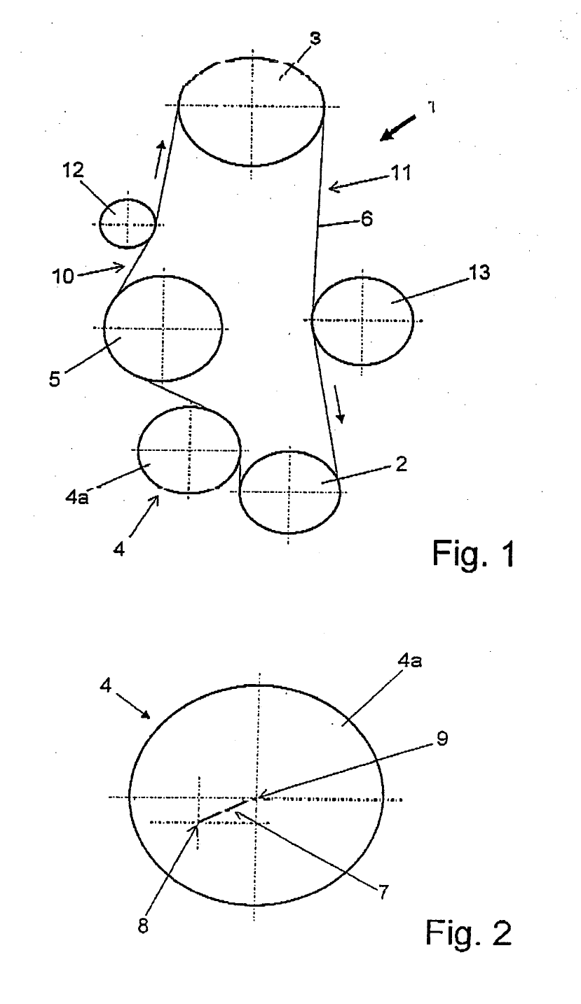

The wraparound drive 1 represented in FIG. 1 first of all comprises a driving traction element pulley 2, in this instance the crankshaft pulley of an internal combustion engine (not shown in further detail), a driven traction element pulley 3 in the form of a camshaft pulley known per se, a tensioning device 4 with a tensioning roller 4a and, between the tensioning device 4 and the crankshaft pulley (traction element pulley 2), a traction element pulley 5 of an auxiliary unit, such as, for example, a water pump.

All of the traction element pulleys 2, 3, 5 and the tensioning roller 4a of the tensioning device 4 are operatively connected to one another by means of an endless wraparound means 6. The wraparound means 6 may be formed by a belt or a chain.

As has already been mentioned above, it has been found in tests that the use of drive-damping measures known per se makes it possible for the drive dynamics and force peaks in the wraparound means 6, for example in a belt, to be reduced to such an extent that certain drive components can be simplified in their design.

By drive-damping measures in this respect is meant a noncircular design (ellipse or polygon) and/or an eccentric mounting of at least one driving and/or one driven traction element pulley 2, 3, 5.

In the present case, all of the traction element pulleys 2, 3 and 5 are noncircular, as a result of which it is possible to significantly compensate for mechanical vibration excitations which occur naturally on account of torque fluctuations or angular velocity and rotational speed variations during the operation of the internal combustion engine and which in turn can load a belt or chain drive.

What is essentially produced here are as it were additional irregularities of shape which in turn shift a critical resonance range of the flexible drive to a nondisruptive range.

As a result of these measures it is now possible for an automatic tensioning system as favored up until now by those skilled in the art, such as a spring-loaded tensioning roller (see, for example, DE 195 20 508 A1), to be replaced by a tensioning device 4 which is simple and inexpensive to manufacture and which, in turn, has a noncircular tensioning roller 4a.

As extremely schematically represented in FIG. 2, the tensioning roller 4a can be positioned with respect to the wraparound means 6 via an eccentric 7 and subsequently fastened in this operating position or in an offcenter fastening point 8.

There has thus been provided an inexpensive and, by contrast with the prior art, an as it were rigid tensioning system with a tensioning roller 4a which, in the operating state, has a point of rotation 9 which is fixed with respect to the wraparound means 6.

In combination with the above-described drive-damping measures known per se, sufficient tensioning of the wraparound means 6 is possible. Accordingly, the tensioning roller 4a is merely geometrically fastened during the final assembly; conventional automatic retensioning during running operation is now unnecessary.

As can also be seen from FIG. 1, a so-called damping roller 12 and 13 is arranged respectively both on the slack strand 10 and on the tight strand 11 of the wraparound drive 1. These damping rollers 12, 13 may in this case likewise be designed to be drive-damping, that is to say be noncircular, for example. An eccentric arrangement of the damping rollers 12, 13, if appropriate in combination with a noncircular form thereof, is also possible (not represented in further detail).

As regards the damping roller 12 on the slack strand 10 of the wraparound drive 1, the best results with regard to drive damping can be achieved if said roller is arranged, as seen in the running direction (arrow direction) of the wraparound means 6, at least behind the tensioning device 4 described and, as in the present case, also behind the traction element pulley 5 of the auxiliary unit.

If a belt is used instead of a chain as the wraparound means 6, it has proved particularly advantageous in respect of the drive damping in question if, instead of a conventional toothed belt, an elastic wraparound means 6, namely a so-called elastomer belt, is used in combination with the above measures, it being possible for this elastomer belt in turn to be designed with variable longitudinal elasticities, for example.

### REFERENCES

1 wraparound drive
2 traction element pulley (crankshaft pulley)
3 traction element pulley (camshaft pulley)
4 tensioning device
4a tensioning roller
5 traction element pulley (auxiliary unit)
6 wraparound means
7 eccentric
8 fastening point
9 point of rotation
10 slack strand
11 tight strand
12 damping roller (in the slack strand 10)
13 damping roller (in the tight strand 11)

1. Wraparound drive comprising a wraparound means, with at least one driving traction element pulley and at least one driven traction element pulley and also with a tensioning device arranged on the slack strand of the wraparound drive, the at least one driving traction element pulley and/or the at least one driven traction element pulley being noncircular and/or eccentrically mounted, and wherein the tensioning device includes a noncircular tensioning roller which can be positioned with respect to the wraparound means via an eccentric and can be fastened to produce a fixed point of rotation.

2. Wraparound drive according to claim 1, wherein one or more noncircular and/or eccentrically mounted damping rollers are arranged on the slack strand and/or on the tight strand of the wraparound drive.

3. Wraparound drive according to claim 2, wherein a damping roller arranged on the slack strand is arranged behind the tensioning device as seen in the running direction of the wraparound means.

4. Wraparound drive according to claim 1, wherein the wraparound means is formed by an elastomer belt.
